(19) United States
(12) Patent Application Publication
(10) Pub. No.: US 2024/0286069 A1
(43) Pub. Date: Aug. 29, 2024

(54) FILTER STRUCTURE

(71) Applicant: TOYO ALUMINIUM EKCO PRODUCTS CO., LTD., Osaka-shi, Osaka (JP)

(72) Inventors: Masashi ADACHI, Osaka-shi, Osaka (JP); Takuto YAMAGISHI, Osaka-shi, Osaka (JP); Mei YAMAGISHI, Osaka-shi, Osaka (JP)

(73) Assignee: TOYO ALUMINIUM EKCO PRODUCTS CO., LTD., Osaka-shi, Osaka (JP)

(21) Appl. No.: 18/570,772

(22) PCT Filed: Jun. 14, 2022
(86) PCT No.: PCT/JP2022/023703

§ 371 Date: Dec. 15, 2023

(30) Foreign Application Priority Data
Jun. 15, 2021 (JP) 2021-099481

(51) Int. Cl. B01D 46/10

(52) U.S. Cl. CPC B01D 46/10; B01D 2265/04; B01D 2275/206; B01D 2279/50

(57) ABSTRACT

Filter structure including filter layer having air permeability to filter gas passing therethrough and adhesive layer of adhesive on at least part of one surface of the filter layer. A size of the filter layer is appropriate for the dimension of a first object, in case of attachment to a second object having a dimension smaller than that of the first object, the filter layer configured to be cut at a predetermined position, in which the adhesive layer includes a strip contour adhesive layer continuous along a contour of the filter layer and a strip partition adhesive layer continuous along at least part of the contour adhesive layer, at a predetermined interval therefrom, within the contour adhesive layer, a cut region being set between the contour adhesive layer and the partition adhesive layer so that the filter layer is cut to a size appropriate for a size of the second object.

### TECHNICAL FIELD

The present invention relates to a filter structure that is attached to an air inlet of an object of an air conditioner (hereinafter, referred to as an air conditioner) to filter passing gas.

### BACKGROUND ART

Filter structures attached to an air inlet to filter gas passing therethrough have been used in order to remove dust and the like from gas which is drawn in during operation of an air conditioner or the like. Conventional filter structures generally have a sheet-like filter layer made of a material having air permeability such as a nonwoven fabric, an adhesive layer formed of adhesive on one surface of the filter layer, and a sheet layer such as a release sheet laminated on the surface of the adhesive layer.

Known examples of the conventional filter structures include a filter structure mainly intended for use in a household air conditioner, and further, a filter structure intended for use in a relatively large ceiling-mounted air conditioner for commercial use (see JP2011-153725A) such as a filter structure described in JP3101063Y.

### CITATION LIST

### Patent Literature

PTL 1: JP3101063Y
PTL 2: JP2011-153725A

Since commercial air conditioners come in a variety of sizes, the dimensions of a filter structure covering an air inlet need to be changed accordingly. However, PTL 1 describes only one size of the filter structure. Therefore, in a case where the dimensions of an air inlet of an air conditioner to which the filter structure is to be attached do not match the dimensions of the filter structure prepared in advance, a problem that the filter structure covers only a part of the air inlet may arise, or, conversely, a problem that the filter structure is too large and interferes with an air outlet provided around the air inlet may arise. It may be possible to prepare filter structures different according to the dimensions of commercial air conditioners. However, this involves preparing a large variety of products, which complicates the management of manufacturing, distribution, inventory, and so on.

The invention has been achieved in light of such problems, and therefore, an object of the invention is to provide one type of filter structure that can be used for a plurality of types of objects having different dimensions to which the filter structure is to be attached.

### SUMMARY OF INVENTION

In order to achieve the object, a filter structure according to a first aspect of the invention is a filter structure including a filter layer that has air permeability to filter passing gas and an adhesive layer formed of adhesive on at least a part of a surface of the filter layer, a size of the filter layer being set to be appropriate for a dimension of a first object to which the filter layer is to be attached, in a case of attachment to a second object having a dimension smaller than that of the first object, the filter layer being configured to be cut at a predetermined position, in which the adhesive layer includes a strip-shaped contour adhesive layer that is continuous along a contour of the filter layer and a strip-shaped partition adhesive layer that is continuous along at least a part of the contour adhesive layer, at a predetermined interval from the contour adhesive layer, within the contour adhesive layer; and an appropriate cut region is set between the contour adhesive layer and the partition adhesive layer so that the filter layer is cut to have a size appropriate for a size of the second object.

With this configuration, the following effect 1 is achieved: In a case where the filter structure is cut within the appropriate cut region set between the strip-shaped contour adhesive layer and the strip-shaped partition adhesive layer, the filter layer has a size suitable for the size of the second object.

According to a second aspect of the invention, the filter structure has the configuration of the invention according to the first aspect in which the adhesive layer includes a plurality of partition adhesive layers with different intervals from the contour adhesive layer.

With this configuration, the following effect 2 is achieved: A plurality of appropriate cut regions is provided, so that a plurality of types of filter layers having different dimensions after cutting can be obtained.

According to a third aspect of the invention, the filter structure has the configuration of the invention according to the first aspect or the second aspect in which the partition adhesive layer is formed to be continuous along a part of the contour adhesive layer and be connected, at an end of the partition adhesive layer, to another part of the contour adhesive layer.

With this configuration, the following effect 3 is achieved: The adhesive layer is continuous over almost the entire circumference of the filter layer cut within the appropriate cut region.

According to a fourth aspect of the invention, the filter structure has the configuration of the invention according to any one of the first to third aspects in which the appropriate cut region set between the contour adhesive layer and the partition adhesive layer is so configured that the filter layer before cutting and the filter layer after cutting are similar to each other.

With this configuration, the following effect 4 is achieved: The shape of the post-cut filter layer is kept similar to the shape of the filter layer before the cut.

According to a fifth aspect of the invention, the filter structure has the configuration of the invention according to any one of the first to four aspects in which in the filter layer, at least one planned excised region for excising a part of the filter layer is set, the adhesive layer further includes a boundary adhesive layer that is formed on a non-excised side of the filter layer to be continuous along a contour of the planned excised region, and the boundary adhesive layer is continuous with the contour adhesive layer.

With this configuration, the following effect 5 is achieved: When the planned excised region is excised, the adhesive layer is continuous along the excised part.

According to a sixth aspect of the invention, the filter structure has the configuration of the invention according to the fifth aspect in which the object is a ceiling-embedded air conditioner in which a sensor is provided at least a part of an inside or a periphery of an air inlet, and the planned excised region of the filter layer is provided at a position corresponding to the sensor.

With this configuration, the following effect 6 is achieved: In a case where the planned excised region is excised, the filter layer does not interfere with the sensor of the air conditioner.

According to a seventh aspect of the invention, the filter structure has the configuration of the invention according to the fifth aspect or the sixth aspect in which the filter layer has a rectangular shape or a square shape, the planned excised region is set in a region including at least one of four corners of the filter layer, the adhesive layer further includes a plurality of grid-like adhesive layers formed in parallel to the contour adhesive layer, the boundary adhesive layer corresponding to the planned excised region is formed by a part of the grid-like adhesive layers, and a part of the grid-like adhesive layers is selectable as the partition adhesive layer.

With this configuration, the following effect 7 is achieved: The boundary adhesive layer and the partition adhesive layer are formed by the grid-like adhesive layer.

According to an eighth aspect of the invention, the filter structure has the configuration of the invention according to any one of the first to seventh aspects in which a sheet layer that is laminated on a surface of the adhesive layer and is peelable is further included.

With this configuration, the following effect 8 is achieved: The sheet layer protects the surface of the adhesive layer.

According to a ninth aspect of the invention, the filter structure has the configuration of the invention according to the eighth aspect in which the sheet layer includes at least two split sheet layers that are separated at least an intermediate position or near the intermediate position on the filter layer, the adhesive layer further includes at least two strip-shaped reinforcing adhesive layers that are formed along adjacent contours of the adjacent split sheet layers, and a width dimension of the reinforcing adhesive layer is set to be larger than a width dimension of the contour adhesive layer and/or the partition adhesive layer.

With this configuration, the following effect 9 is achieved: At least the two reinforcing adhesive layers having a width dimension larger than that of the contour adhesive layer and/or the partition adhesive layer are formed at or near the intermediate position of the filter layer where the sheet layer is divided.

As described above, since the filter structure according to the first aspect of the invention achieves the effect 1, it is easy to change the size of the filter layer to a size suitable for the second object. Further, one type of filter structure can adapt to at least two different sizes of objects.

The filter structure according to the second aspect of the invention achieves the effect 2 in addition to the effect of the invention according to the first aspect. Thus, one type of filter structure can adapt to plural types of objects with different dimensions.

The filter structure according to the third aspect of the invention achieves the effect 3 in addition to the effect of the invention according to the first aspect or the second aspect. Thus, a gap between the filter layer and the object is blocked by the adhesive over almost the entire circumference of the post-cut filter layer. This prevents gas from being sucked in without passing through the filter layer.

The filter structure according to the fourth aspect of the invention achieves the effect 4 in addition to the effect of the invention according to any one of the first aspect to the third aspect. This facilitates using the filter structure for objects that have basically a square shape with different dimensions such as commercial air conditioners.

The filter structure according to the fifth aspect of the invention achieves the effect 5 in addition to the effect of the invention according to any one of the first aspect to the fourth aspect. This facilitates confirming the range of the planned excised region by the boundary adhesive layer. Further, a gap between the object and an edge of a non-excised side part in the filter layer is blocked by the adhesive layer. This prevents gas from being sucked in without passing through the filter layer.

The filter structure according to the sixth aspect of the invention achieves the effect 6 in addition to the effect of the invention according to the fifth aspect. Therefore, the function of the sensor in the air conditioner is maintained normally.

The filter structure according to the seventh aspect of the invention achieves the effect 7 in addition to the effect of the invention according to the fifth aspect or the sixth aspect. Thus, since it is only necessary to form the grid-like adhesive layer in the filter layer, the formation pattern of the adhesive layer can be simplified and the production efficiency is improved.

The filter structure according to the eighth aspect of the invention achieves the effect 8 in addition to the effect of the invention according to any one of the first aspect to the seventh aspect. This prevents a loss of adhesion in use of the filter structure caused by a foreign matter adhering to the surface of the adhesive layer before the filter structure is used, and prevents the adhesive layer from sticking to an object other than the intended object. Further, it becomes possible to stack a plurality of filter structures, which enables improved handling.

The filter structure according to the ninth aspect of the invention achieves the effect 9 in addition to the effect of the invention according to the eighth aspect. Therefore, a part of the split sheet layer is peeled off and the filter layer can be reliably adhered to the object one part at a time. This facilitates attaching the filter structure to the object.

### BRIEF DESCRIPTION OF DRAWINGS

FIG. 1 is a front view illustrating an example of a filter structure according to an embodiment of the invention.

FIG. 2 is a perspective view in which a part of the filter structure of FIG. 1 is enlarged, and illustrates a state in which a sheet layer is partly peeled off.

FIG. 3 is a front view illustrating a setting example of an appropriate cut region in the filter structure of FIG. 1.

FIG. 4 is a front view illustrating a state in which a part of a filter layer is cut in an appropriate cut region and a planned excised region in the filter structure of FIG. 1.

FIG. 5 is a partially enlarged front view for demonstrating the relationship between the width dimensions of individual adhesive layers in the filter structure of FIG. 1.

FIG. 6 is a front view illustrating other cut examples of the filter structure of FIG. 1.

### DESCRIPTION OF EMBODIMENTS

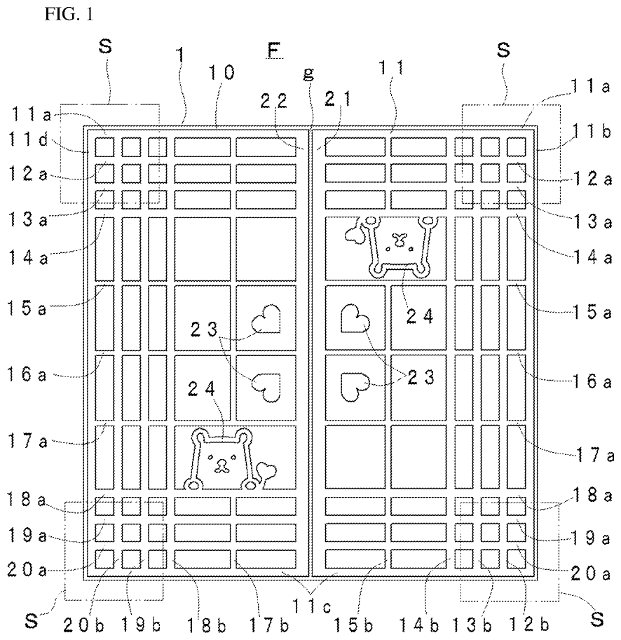

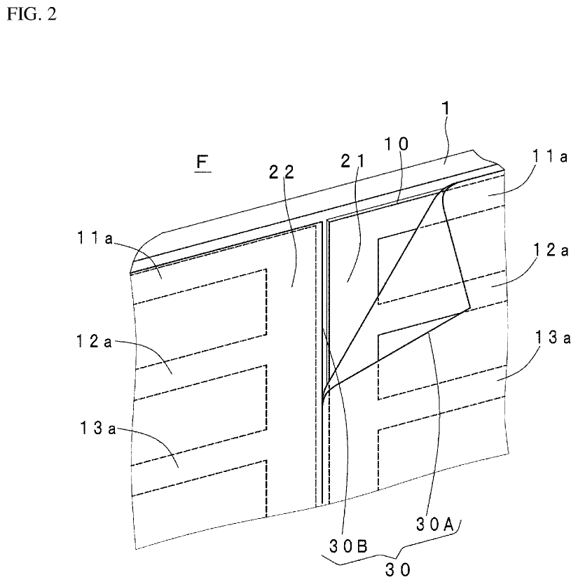

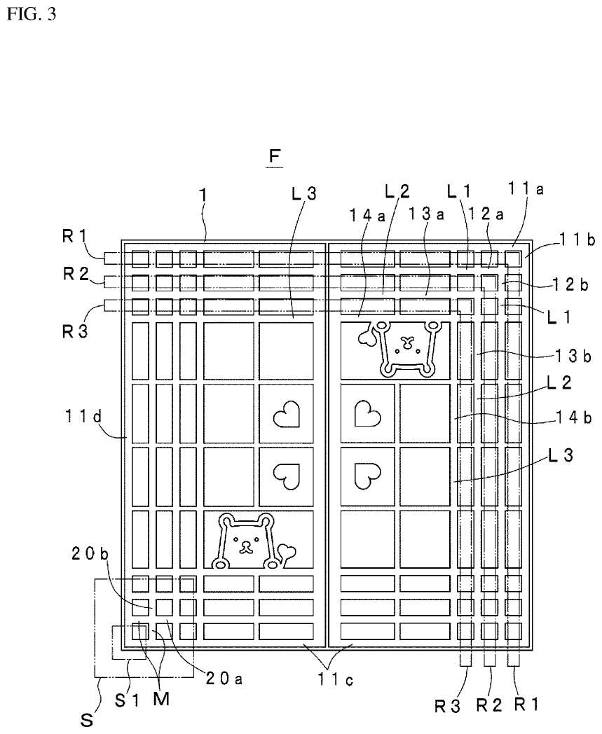

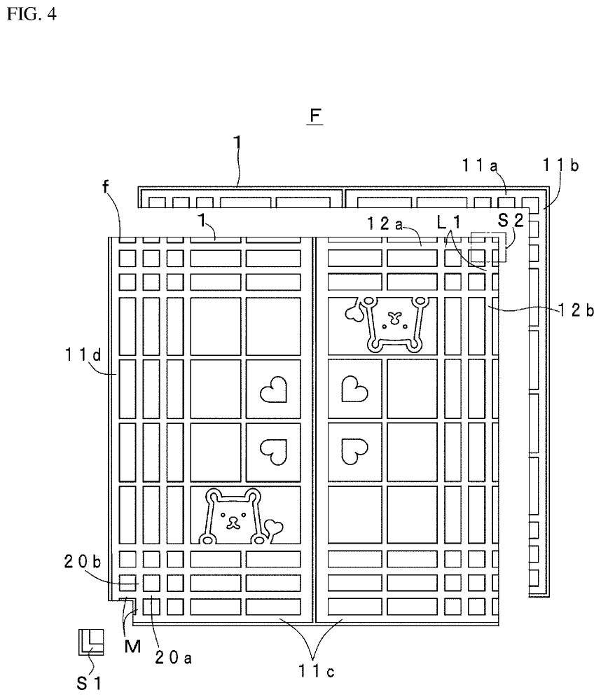

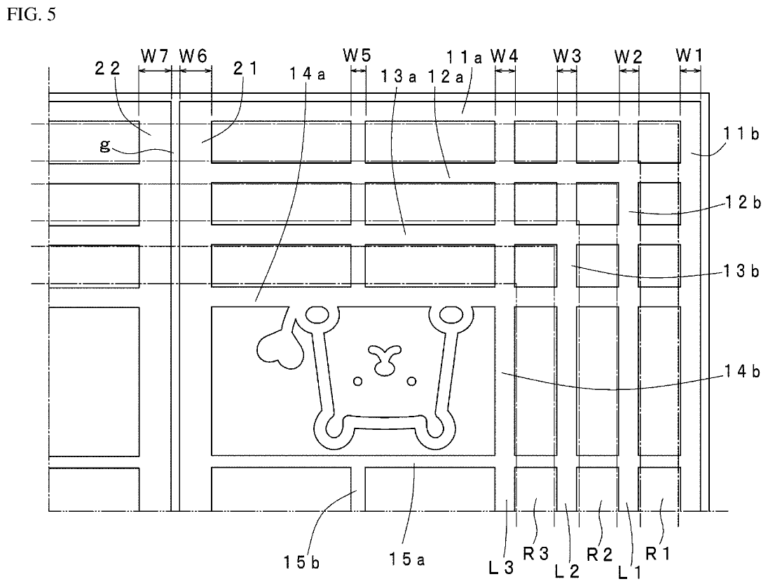

FIG. 1 is a front view illustrating an example of a filter structure according to an embodiment of the invention. FIG. 2 is a perspective view in which a part of the filter structure of FIG. 1 is enlarged, and illustrates a state in which a sheet layer is partly peeled off. FIG. 3 is a front view illustrating a setting example of an appropriate cut region in the filter structure of FIG. 1. FIG. 4 is a front view illustrating a state in which a part of a filter layer is cut in an appropriate cut region and a planned excised region in the filter structure of FIG. 1. FIG. 5 is a partially enlarged front view for demonstrating the relationship between the width dimensions of individual adhesive layers in the filter structure of FIG. 1.

A filter structure F of this embodiment is intended for use in a ceiling-embedded air conditioner for commercial use, and is attached to an air inlet to filter gas passing therethrough to prevent dust and the like from being directly sucked in. For example, the air conditioner described in PTL 2 has a structure in which a panel facing the interior of a room has a substantially square contour, a substantially square air inlet is provided at the center of the panel, and an air outlet is disposed outside the four sides of the air inlet. The filter structure F of this example has a square shape according to the shape of the air inlet of the air conditioner.

The filter structure F includes a sheet-like filter layer 1 that has air permeability to filter gas passing therethrough, an adhesive layer 10 that is formed of adhesive on at least a part of one surface of the filter layer 1 to provide adhesion to an object, and a sheet layer 30 that is laminated on the surface of the adhesive layer 10 and is peelable.

The filter layer 1 is made of, for example, a nonwoven fabric, a woven fabric, or a knitted fabric. The filter layer 1 serves to capture dust and the like and also allows gas to flow, and has practical strength. Preferably, nonwoven fabrics made of synthetic resin fibers such as polyester, e.g., polyethylene terephthalate (PET), copolymers mainly made of polypropylene or propylene, and acrylics including modacrylic can be used, but the nonwoven fabrics are not limited thereto. A method for manufacturing nonwoven fabrics is not limited either, and nonwoven fabrics produced by using known manufacturing methods such as chemical bonding or thermal bonding may be suitably used. Further, the filter layer 1 may be subjected to processing such as antiviral finishing or antibacterial treatment.

The adhesive forming the adhesive layer 10 is not particular limited. The adhesive can be, for example, two-liquid mixing type adhesive containing a main agent and a hardener such as two-liquid mixing type polyurethane adhesive, hot-melt adhesive such as acrylic hot-melt adhesive, or the like. In addition, if necessary, the adhesive may blend additives such as a tackifier that improves adherence, an ultraviolet absorber, a filler, a colorant, an antioxidant, an antifoam agent, and a light stabilizer as well as various additives to prevent a loss of adhesion, adhesive residue, and the like at low temperatures. As a method for forming the adhesive layer on the filter layer, known methods can be used. For example, the following method can be used: A coating film is formed by applying the adhesive directly to a nonwoven fabric, or by indirectly applying the adhesive once to a peelable sheet layer described later and the like to bring the sheet layer and the nonwoven fabric into contact with each other to transfer the adhesive to the nonwoven fabric, and then the coating film is dried (solidified). The method of application for directly or indirectly applying the adhesive layer to the filter layer is not limited, but the method of application can be implemented with a roller, a spray, a brush, printing, etc. That is, for example, any of roll coater method, comma coater method, die coater method, inkjet method, reverse coater method, silk screen method, gravure coater method and the like using known equipment can be employed. In the case of indirect application, for example, a method can be used in which the adhesive layer is transferred to the filter layer by printing the adhesive on a peelable sheet layer coated with silicone with a roll or the like, and then, bringing the adhesive layer side of the sheet layer into contact with the filter layer to press and attach the resultant by using a roll or the like.

The sheet layer 30 may be, for example, a PET film with silicon coating formed on at least one surface, or the like. Providing the sheet layer protects the surface of the adhesive layer; therefore, it is possible to prevent the adhesive layer from sticking to an object other than the intended object before the filter structure is used. It is also possible to stack a plurality of filter structures, which enables improved handling. At the time of use, the sheet layer is peeled off to attach the exposed adhesive layer to an object, like a sticker. As the material of the sheet layer 30, in addition to a PET film, Cellophane, resin films other than PET, paper with a surface finish such as resin coating, metal sheets, and the like can be used.

The filter structure F in this example is characterized by the formation pattern of the adhesive layer 10. Referring to FIG. 1, the filter layer 1 of this example has a substantially square shape, and a nearly continuous strip-shaped contour adhesive layer 11 is formed along the contour of the filter layer 1. The contour adhesive layer 11 has a pair of transverse contour adhesive layers 11a and 11c extending in the transverse direction and a pair of longitudinal contour adhesive layers 11b and 11d extending in the longitudinal direction.

Inside the region surrounded by the contour adhesive layer 11, a plurality of strip-shaped adhesive layers 12a to 20a formed parallel to the transverse contour adhesive layers 11a and 11c is formed, also, a plurality of strip-shaped adhesive layers 12b to 20b formed parallel to the longitudinal contour adhesive layers 11b and 11d is formed, so that the grid-like adhesive layer is formed. Further, at the intermediate position of the filter layer 1, two strip-shaped reinforcing adhesive layers 21 and 22 are formed in parallel with a slight gap g therebetween. Further, in a region surrounded by the grid of the adhesive layer at the center of the filter layer 1, design adhesive layers 23 and 24 formed in a heart shape or a character design are provided.

The filter structure F of this example has the adhesive layer 10 having the form described above, so that the filter structure F can adapt to air conditioners with different sizes of air inlets. Referring to FIG. 3, for example, an L-shaped part formed by the adhesive layer 12a that is parallel to the transverse contour adhesive layer 11a and closest to the transverse contour adhesive layer 11a and the adhesive layer 12b that is parallel to the longitudinal contour adhesive layer 11b and closest to the longitudinal contour adhesive layer 11b is defined as a first partition adhesive layer L1. Further, a region between the first partition adhesive layer L1 and the transverse contour adhesive layer 11a as well as the longitudinal contour adhesive layer 11b is defined as a first appropriate cut region R1. A case is taken as an example in which an object to which the filter structure F is to be attached is changed from an air conditioner (first object) having an air inlet with a size appropriate to attach the entire filter layer 1 to an air conditioner (second object) having an air inlet with a size smaller than the filter layer 1. In such a case, when the filter layer 1 is cut within the first appropriate cut region R1, the size of the post-cut filter layer 1 is set to be appropriate for the size of the air inlet of the air conditioner that is the second object.

In the filter structure F of the example configured as described above, as illustrated in FIG. 4, the filter layer 1 is cut within the first appropriate cut region R1 along the first partition adhesive layer L1, so that a filter structure f having a size appropriate for the inlet of the air conditioner that is the second object can be obtained. At this time, ends of the first partition adhesive layer L1 are connected to the contour adhesive layers 11c and 11d, and thus, the adhesive layer is almost continuous at the cut ends of the post-cut filter structure f. Stated differently, in the post-cut filter structure f, the first partition adhesive layer L1 and the contour adhesive layers 11c and 11d form a closed curve. Accordingly, when the post-cut filter structure f is attached to an object, the structure can be achieved in which the gap between the filter layer 1 and the object is blocked by the adhesive layer over almost the entire circumference of the filter layer 1. As a result, in the post-cut filter structure, it is possible to prevent gas from being sucked in without passing through the filter layer.

In this example, the adhesive layer in the transverse direction is slightly discontinuous at the gap g (for example, 5 mm or less, but may be 2 to 3 mm); however, this amount of discontinuity in the adhesive layer is permissible and no practical problem arises.

Further, in this example, an L-shaped second partition adhesive layer L2 and an L-shaped third partition adhesive layer L3 are defined by adhesive layers 13a, 13b, 14a, and 14b that are different from the first partition adhesive layer L1 in distances from the transverse contour adhesive layer 11a and the longitudinal contour adhesive layer 11b, a region between the first partition adhesive layer L1 and the second partition adhesive layer L2 is defined as a second appropriate cut region R2, and a region between the second partition adhesive layer L2 and the third partition adhesive layer L3 is defined as a third appropriate cut region R3. Thereby, the filter structure F can be fitted for another air conditioner (object) with a smaller air inlet by cutting the filter layer 1 within the second appropriate cut region R2 along the second partition adhesive layer L2, or alternatively, by cutting the filter layer 1 within the third appropriate cut region R3 along the third partition adhesive layer L3. Therefore, the filter structure F of this example can be used for four types of objects having different sizes, including a case where the filter layer 1 is not cut and cases where the filter layer 1 is cut in the individual three appropriate cut regions.

Further, in this example, all of the post-cut filter layers are configured to have a substantially square shape similar to the shape of the original filter layer. This configuration facilitates application to objects having a basically square shape but having different dimensions, such as commercial air conditioners, for example.

In the meantime, as in the air conditioner described in PTL 2, a sensor for detecting the human body or temperature is sometimes disposed around the air inlet. When the filter structure is attached, the sensor might be covered by the filter layer depending on the location of the sensor. To address this, in this example, a planned excised region S is set in order to excise a part of the filter layer 1 which may correspond to the sensor. The specific configuration is as follows: Each of parts including four corners of the filter layer 1 having a substantially square shape is regarded as the planned excised region S, one or more of the planned excised regions S are selected, and a part of the selected planned excised region (s) is excised within the planned excised region S according to the size of an object to be excluded.

Referring to FIGS. 3 and 4, in this example, a plurality of grid-like adhesive layers is formed in the planned excised region S. The grid-like adhesive layers are configured to form a boundary adhesive layer M in which the adhesive is continuous along the contour of the non-excised side of the filter layer 1 in which a part of the planned excised region S has been excised. For example, in a case where one of four planned excised regions S is selected and a part S1 thereof is excised along the adhesive layers 20a and 20b, the boundary adhesive layer M that is continuous in an L-shape along the contour of the non-excised region side is formed by the adhesive layers 20a and 20b. Since the boundary adhesive layer M is connected to the transverse contour adhesive layer 11c and the longitudinal contour adhesive layer 11d, when a cut end after excising the part S1 is attached to an object, the adhesive can block the gap between the filter layer 1 and the object. Further, in this example, the grid-like adhesive layer is formed within the planned excised region S, which makes it easy to grasp an excised range according to the object to be excluded. This configuration also applies to the planned excised regions S of the other corners.

In a case where the filter structure F configured as described above is attached to an air inlet of an air conditioner, a gap between a part around the air inlet and the filter layer can be securely blocked with the adhesive, which prevents dust and the like from being directly sucked in the air inlet without passing through the filter layer.

Referring to FIG. 5, in the filter structure F of this example, the width dimensions of the adhesive layers are set, for example, as follows. To be specific, the width dimensions W1 of the contour adhesive layers 11a and 11b and the respective width dimensions W2, W3, and W4 of the partition adhesive layers L1, L2, and L3 are almost equal, the width dimensions W6 and W7 of the reinforcing adhesive layers 21 and 22 are set to be larger than W1 and be the largest, and the width dimensions W5 of the other adhesive layers (15a and 15b, for example) are set to be smaller than W1 and be the smallest.

Further, the sheet layer 30 includes two split sheet layers 30A and 30B (see FIG. 2) divided at the intermediate position of the filter layer 1. The split sheet layers 30A and 30B each cover a half of the filter layer 1 and are separated at the position of the gap g between the reinforcing adhesive layers 21 and 22.

Such a configuration contributes to ease of attachment in the case of a large-sized product such as a filter structure for commercial air conditioner. In attaching the filter structure F, first, any one of the two split sheet layers (30A, for example) is peeled off to expose a half of the entire adhesive layer 10, and the resultant is attached to an air inlet of an air conditioner. In this state, the other split sheet layer (30B, for example) is peeled off to expose the adhesive layer of the residual half, and the resultant is attached to the residual part of the air inlet. At this time, when the filter layer is attached with one of the split sheet layers peeled off, a half of the filter structure before attachment may hang down from the intermediate position. Then, the load acts on a part of one middle reinforcing adhesive layer (21, for example), so that in a case where a retention force of the reinforcing adhesive layer is insufficient, the part attached first may come off during the attaching work. However, in this example, the width dimensions of the reinforcing adhesive layers 21 and 22 are set to be larger than the width dimensions of the contour adhesive layers and the partition adhesive layers. Thus, the problem described above is less likely to occur, and the effect of reliably keeping a state in which a half of the filter structure is attached can be achieved.

Further, since the gap g in which no adhesive layer is formed is provided between the two reinforcing adhesive layers 21 and 22, the filter layer is folded more easily at the part than the other parts. Therefore, the filter structure is folded to the side opposite to the sheet layer to expose a part between the split sheet layers where no adhesive layer is formed. This enables the split sheet layers to be peeled off easily.

The design adhesive layers 23 and 24 contribute to attachment of the filter layer to an object, and indicate when to replace the filter structure F. Specifically, accumulation of dust and the like changes the color of a part of the filter layer 1 through which air passes, whereas the color of the filter layer 1 at a part where the adhesive layer is formed does not change because air circulation is reduced at the part. As a result, as the filter structure F continues to be used, the forms of the design adhesive layers 23 and 24 can be visually recognized as if they stand out, so that it is possible to know when to replace the filter structure F.

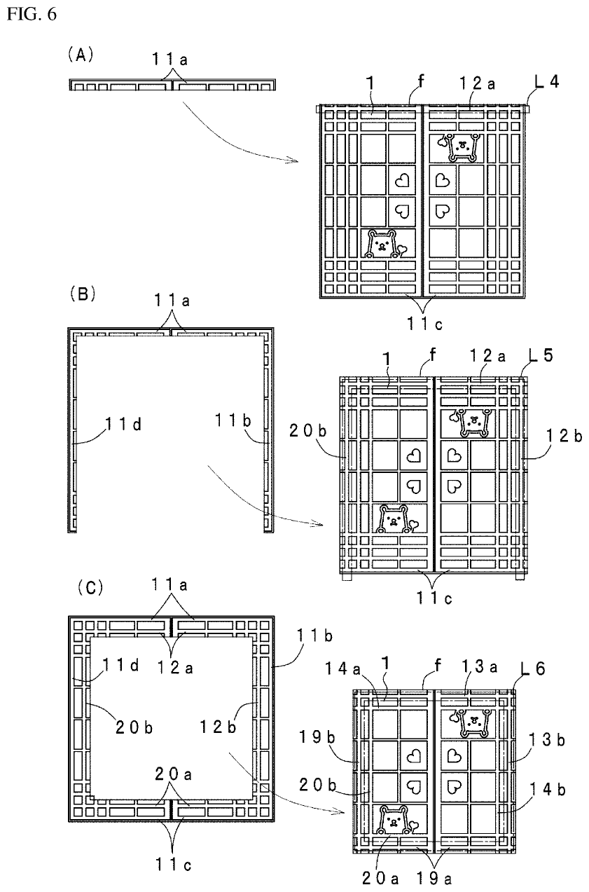

FIG. 6 is a front view illustrating other cut examples of the filter structure of FIG. 1.

In the cut example illustrated in FIG. 4, among the contour adhesive layers 11 along the four sides of the filter layer 1, the specific two contour adhesive layers 11a and 11b adjacent to each other are used as the reference, and the adhesive layers 12a and 12b closest thereto are defined as the L-shaped partition adhesive layer L1 for cutting the filter layer 1. However, the invention is not limited thereto, and the partition adhesive layer may have a liner shape along only one side of the contour adhesive layer, a U-shape along three sides of the contour adhesive layer, or a square shape along all the four sides of the contour adhesive layer. Specifically, as illustrated in (A) of FIG. 6, one adhesive layer 12a along the contour adhesive layer 11a may be defined as a partition adhesive layer L4 to cut the filter layer 1 linearly. Alternatively, as illustrated in (B) of FIG. 6, the three adhesive layers 12a, 12b, 20b along the three contour adhesive layers 11a, 11b, and 11d may be defined as a partition adhesive layer L5 to cut the filter layer 1 in a U-shape. Yet alternatively, as illustrated in (C) of FIG. 6, the four adhesive layers 13a, 13b, 19a, and 19b along all of the contour adhesive layers 11 (11a to 11d) may be defined as a partition adhesive layer L6 to cut the filter layer 1 in a square shape. Incidentally, in the example of (C) of FIG. 6, an adhesive layer located inside as compared with that of (A) and (B) of FIG. 6 is selected as the partition adhesive layer L6 and the post-cut filter structure f is configured to fit an object having relatively small dimensions.

Further, in the example of (A) of FIG. 6, along with the partition adhesive layer L4, one of the adhesive layers closer to the other contour adhesive layer 11c parallel to the partition adhesive layer L4 may be defined as the partition adhesive layer, and both ends of the filter layer 1 facing each other may be linearly cut. In the example of (B) of FIG. 6, the partition adhesive layer may be defined by using an adhesive layer located inside as compared with the partition adhesive layer L5. In the example of (C) of FIG. 6, the partition adhesive layer may be defined by using the adhesive layers 13a, 13b, 19a, and 19b located inside as compared with the partition adhesive layer L6, or, the partition adhesive layer may be defined by using the adhesive layers 12a, 12b, 20a, and 20b located outside of the partition adhesive layer L6. These aspects are adopted to thereby achieve filter structures f having various post-cut sizes.

Further, in the embodiment illustrated in FIG. 3, the partition adhesive layers L1, L2, and L3 are set at a plurality of positions so that the filter layer can be changed to three different sizes. However, a single partition adhesive layer corresponding to a change to one size may be used, or a partition adhesive layer may be configured to change to four or more different sizes.

The position setting of the partition adhesive layer described above is one example, and the partition adhesive layer may be set at another position with reference to the contour adhesive layer at another position. The number of partition adhesive layers and other adhesive layers formed may be greater or smaller than those illustrated in the drawings.

Further, in the foregoing embodiments, the shape of the filter layer after cutting in the appropriate cut region is set to be similar to that of the original filter layer. However, the post-cut shape of the filter layer does not need to be similar to that of the original filter layer.

Further, the filter structure of this example has the planned excised region S at each of the four corners. It is thus possible to select a planned excised region at a position that does not interfere with the partition adhesive layers set at any position.

Further, the planned excised region is preferably set at, out of the four corners of the filter layer, at least one corner. Alternatively, it is possible to set the planned excised region at a specific one corner and set the partition adhesive layer at a prefixed position accordingly. The size of a part to be excised actually in the planned excised region can be changed appropriately, and an area larger than the part S1 illustrated in FIG. 3 may be excised or the entire planned excised region S may be excised. To be specific, in the examples illustrated in FIGS. 3 and 4, the planned excised region S is divided into nine squares by the grid-like adhesive layer, and S1 having only one square thereof is excised. Instead of this, it is possible to excise two squares or more, or to delete all of the nine squares. Further, in the example of FIG. 4, in the filter structure f that has been cut along the partition adhesive layer L1, a region including a corner of the post-cut filter layer 1 (diagonal position of S1, for example) may be defined as a new planned excised region S2. Further, two or more parts may be excised within the planned excised region. Among the planned excised regions at the four corners, planned excised regions at a plurality of parts may be selected as objects to be excised.

Further, the position at which the planned excised region is formed is not limited to a corner. For example, in a case where a sensor is provided on the inner side of the air inlet (corner or center of the air inlet), the planned excised region is preferably set according to the sensor position. Further, perforations or the like may be provided, in advance, at corresponding positions for easy cutting. As described above, the range or number of the planned excised region can be freely set depending on the situation of implementation.

Further, the filter structure of the invention can be used for household or commercial devices such as air purifiers, range hoods for kitchens, and ventilation fans, indoor and outdoor vents, and so on, in addition to air conditioners. In such a case, the adhesive layer at a position appropriately selected from the plurality of grid-like adhesive layers is defined as the partition adhesive layer, and the filter layer is cut along the partition adhesive layer. This enables obtaining a filter structure fit to the size of an intended object.

In the foregoing embodiments, the shape of the filter structure is a square. Instead, various shapes such as rectangle, polygon, circle, and ellipse can be adopted as the shape of the filter structure. In the case of a circle, for example, since the circle has no corners, a part corresponding to an interference part of an object to which the filter structure is to be attached may be defined as the planned excised region, and the boundary adhesive layer may be formed on a non-excised side of the filter layer.

In the foregoing embodiments, the design adhesive layer is formed as a picture or a figure. Instead, it is possible to form the design adhesive layer as a letter, a symbol, or the like indicating when to replace the filter. Further, the design adhesive layer may be omitted.

In the foregoing embodiments, the sheet layer is divided into two. Instead, the sheet layer may be divided into three or more, or, may be a single sheet layer not divided. Further, although the split sheet layers are formed to have almost the same shape, the split sheet layers may have unequal or different shapes.

In the foregoing embodiments, although the width dimension of the reinforcing adhesive layer is set to be the largest, it is only required that the width dimension thereof is larger than a width of at least one of the contour adhesive layer and the partition adhesive layer. Further, although the width dimensions of the contour adhesive layer and the partition adhesive layer are almost the same, they may be different from each other.

Further, in the foregoing embodiments, although two reinforcing adhesive layers are formed with the gap therebetween, the gap may be omitted. Further, the reinforcing adhesive layer may be formed also in the transverse direction. The gap may be formed in the transverse direction.

### INDUSTRIAL APPLICABILITY

According to the invention, a filter structure product is provided which is used for an air inlet of an air conditioner, and is suitable for use in products coming in a variety of types that have basically similar shapes but different dimensions, particularly in commercial air conditioners for example. Further, a filter structure product can be provided which can also adapt to an air conditioner in which a sensor for detecting the human body or temperature is disposed around an air inlet. Further, a filter structure product is provided in which an adhesive layer is formed in a grid-like shape and further a design adhesive layer representing a heart shape or a character design is formed. Further, a filter structure product can be provided which is used for household or commercial devices such as air purifiers, range hoods for kitchens, and ventilation fans, indoor and outdoor vents, and so on, in addition to air conditioners. Further, a filter structure product can be provided which has various shapes of rectangular, polygonal, circular, and elliptical.

1. A filter structure (F) comprising a filter layer (1) that has air permeability to filter passing gas and an adhesive layer (10) formed of adhesive on at least a part of a surface of the filter layer (1), a size of the filter layer being set to be appropriate for a dimension of a first object to which the filter layer is to be attached, in a case of attachment to a second object having a dimension smaller than that of the first object, the filter layer being configured to be cut at a predetermined position,
wherein
the adhesive layer includes a strip-shaped contour adhesive layer (11) that is continuous along a contour of the filter layer and a strip-shaped partition adhesive layer (L1) that is continuous along at least a part of the contour adhesive layer, at a predetermined interval from the contour adhesive layer, within the contour adhesive layer; and
an appropriate cut region (R1) is set between the contour adhesive layer and the partition adhesive layer so that the filter layer is cut to have a size appropriate for a size of the second object.

2. The filter structure according to claim 1, wherein the adhesive layer includes a plurality of partition adhesive layers (L1 to L3) with different intervals from the contour adhesive layer.

3. The filter structure according to claim 1, wherein the partition adhesive layer is formed to be continuous along a part of the contour adhesive layer and be connected, at an end of the partition adhesive layer, to another part of the contour adhesive layer.

4. The filter structure according to claim 1, wherein the appropriate cut region set between the contour adhesive layer and the partition adhesive layer is so configured that the filter layer (1) before cutting and the filter layer (1) after cutting are similar to each other.

5. The filter structure according to claim 1, wherein
in the filter layer, at least one planned excised region (S) for excising a part of the filter layer is set,
the adhesive layer further includes a boundary adhesive layer that is formed on a non-excised side of the filter layer to be continuous along a contour of the planned excised region, and
the boundary adhesive layer is continuous with the contour adhesive layer.

6. The filter structure according to claim 5, wherein
the object is a ceiling-embedded air conditioner in which a sensor is provided at least a part of an inside or a periphery of an air inlet, and
the planned excised region of the filter layer is provided at a position corresponding to the sensor.

7. The filter structure according to claim 5, wherein
the filter layer has a rectangular shape or a square shape,
the planned excised region is set in a region including at least one of four corners of the filter layer,
the adhesive layer further includes a plurality of grid-like adhesive layers (12a to 20a, 12b to 20b) formed in parallel to the contour adhesive layer,
the boundary adhesive layer corresponding to the planned excised region is formed by a part of the grid-like adhesive layers, and
a part of the grid-like adhesive layers is selectable as the partition adhesive layer.

8. The filter structure according to claim 1, further comprising a sheet layer (30) that is laminated on a surface of the adhesive layer and is peelable.

9. The filter structure according to claim 8, wherein
the sheet layer includes at least two split sheet layers (30A, 30B) that are separated at least at an intermediate position or near the intermediate position on the filter layer,
the adhesive layer further includes at least two strip-shaped reinforcing adhesive layers (21, 22) that are formed along adjacent contours of the adjacent split sheet layers, and
a width dimension of the reinforcing adhesive layer is set to be larger than a width dimension of the contour adhesive layer and/or the partition adhesive layer.
